(19) United States
(12) Patent Application Publication
(10) Pub. No.: US 2026/0104628 A1
(43) Pub. Date: Apr. 16, 2026

(54) CAMERA

(71) Applicant: i-PRO Co., Ltd., Tokyo (JP)

(72) Inventors: Akito OMATA, Tokyo (JP); Kento TANAKA, Tokyo (JP); Hirokazu TASAKA, Tokyo (JP)

(73) Assignee: i-PRO Co., Ltd., Tokyo (JP)

(21) Appl. No.: 19/128,045

(22) PCT Filed: Sep. 22, 2023
(86) PCT No.: PCT/JP2023/034608

§ 371 Date: May 7, 2025

(30) Foreign Application Priority Data
Nov. 11, 2022 (JP) 2022-181381

(51) Int. Cl. G03B 17/56; G03B 17/12; G03B 17/48; G03B 19/18

(52) U.S. Cl. CPC G03B 17/56; G03B 17/12; G03B 17/48; G03B 19/18; G03B 2205/0084; G03B 2217/002

(57) ABSTRACT

A camera includes a housing, an installation base provided in the housing, a plurality of camera modules provided on the installation base to be tiltable and rotatable, and a pedestal provided to be movable with respect to the installation base. The pedestal includes a plurality of adjustment portions that respectively support each of the plurality of camera modules and are changeable to a plurality of different tilt angles, and a lever that receives a movement operation of the pedestal and is capable of collectively adjusting the plurality of adjustment portions.

### TECHNICAL FIELD

The present disclosure relates to a camera.

### BACKGROUND ART

Patent Literature 1 discloses a camera assembly in which a plurality of camera lens units (camera modules) are moved along an annular guide rail and disposed such that installation angles thereof can be adjusted. The camera assembly has a problem in that in an assembly process of rotating a cover portion with respect to a base portion and determining installation positions of the camera modules, the camera modules rotate together with the cover portion, changing the installation angles of the camera modules. Therefore, the camera assembly is provided with a cover configured to fix the positions of the camera modules by attaching the guide rail to a surface of the base and disposing a magnet on each of the camera modules such that the magnet faces the guide rail, and by coupling the cover to the base portion, the cover presses at least one of the camera modules and the positions (installation angles) of the plurality of camera modules are collectively fixed.

### CITATION LIST

### Patent Literature

Patent Literature 1: U.S. Pat. No. 10,567,622B

### SUMMARY OF INVENTION

### Technical Problem

However, in the above camera assembly, although the installation angles of the plurality of camera modules can be collectively fixed, tilt angles of these camera modules cannot be collectively adjusted. In such a case, an operator who installs the camera needs to manually adjust the tilt angles of all the camera modules to be the same, which is very labor-intensive.

The present disclosure has been made in view of the above circumstances in the related art, and an object thereof is to provide a camera capable of collectively adjusting tilt angles of all camera modules.

### Solution to Problem

The present disclosure provides a camera including: a housing; an installation base provided in the housing; a plurality of camera modules provided on the installation base to be to be tiltable and rotatable; and a pedestal provided to be movable with respect to the installation base, in which the pedestal includes a plurality of adjustment portions that respectively support each of the plurality of camera modules and are changeable to a plurality of different tilt angles, and a lever that receives a movement operation of the pedestal and is capable of collectively adjusting the plurality of adjustment portions.

### Advantageous Effects of Invention

According to the present disclosure, tilt angles of all camera modules can be collectively adjusted.

### BRIEF DESCRIPTION OF DRAWINGS

FIG. 1 is an external perspective view of a surveillance camera according to Embodiment 1.

FIG. 2 is a perspective view of the surveillance camera.

FIG. 3 is a plan view of a housing.

FIG. 4 is a plan view of the housing.

FIG. 5 is an enlarged perspective view of a main portion illustrating an example of a tilt rotation mechanism.

FIG. 6 is a perspective view illustrating an example of a pedestal.

FIG. 7 is a plan view of the pedestal.

FIG. 8 is an enlarged view of a main portion illustrating a flexible part.

FIG. 9 is a perspective view of the pedestal.

FIG. 10 is an enlarged view of a main portion of the pedestal in a vicinity of an adjustment portion.

FIG. 11 is a perspective view illustrating an example of adjusting a tilt angle of a camera module.

FIG. 12 is a perspective view illustrating the example of adjusting the tilt angle of the camera module.

FIG. 13 is an enlarged perspective view of a main portion of the lever.

FIG. 14 is a plan view illustrating the lever and the pedestal at a position of a middle-distance mark “M”.

FIG. 15 is a plan view illustrating the lever and the pedestal at a position of a short-distance mark “N”.

FIG. 16 is a plan view illustrating the lever and the pedestal at a position of a long-distance mark “F”.

### DESCRIPTION OF EMBODIMENTS

Hereinafter, an embodiment that specifically discloses a camera according to the present disclosure will be described in detail with reference to the drawings as appropriate. The detailed description more than necessary may be omitted. For example, the detailed description of already well-known matters and the redundant description of substantially the same configuration may be omitted. This is to avoid unnecessary redundancy of the following description and facilitate understanding of a person skilled in the art. The accompanying drawings and the following description are provided for a person skilled in the art to sufficiently understand the present disclosure, and are not intended to limit the subject matter described in the claims.

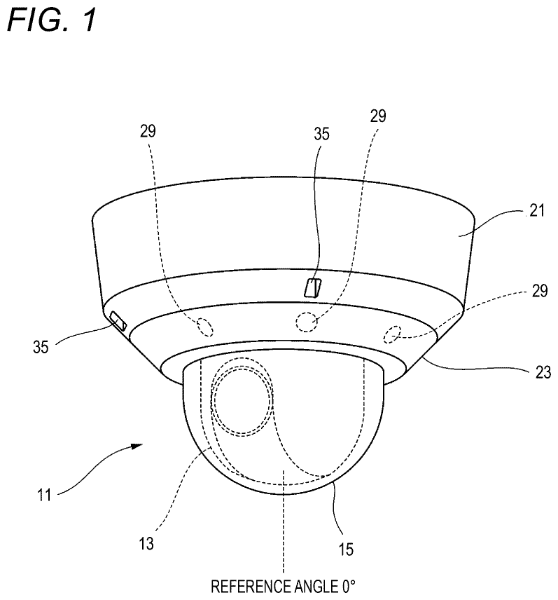

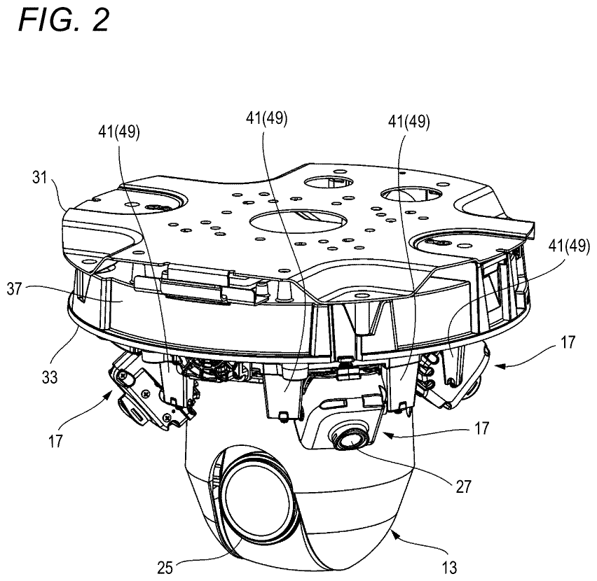

FIG. 1 is an external perspective view of a surveillance camera 11 according to Embodiment 1. In the following description of Embodiment 1, to facilitate understanding of the description, a structure in which a tilt angle of each of a plurality of camera modules 17 (see FIG. 2) included in the surveillance camera 11 can be collectively adjusted will be described. However, the camera according to the present disclosure is not limited to a surveillance application, and may be a camera used for other applications.

The surveillance camera 11 according to Embodiment 1 includes, for example, a dome cover 15 as a protective cover that covers a camera unit 13. The dome cover 15 illustrated in FIG. 1 is an example, and the protective cover may have other shapes. The protective cover is not essential and may be omitted.

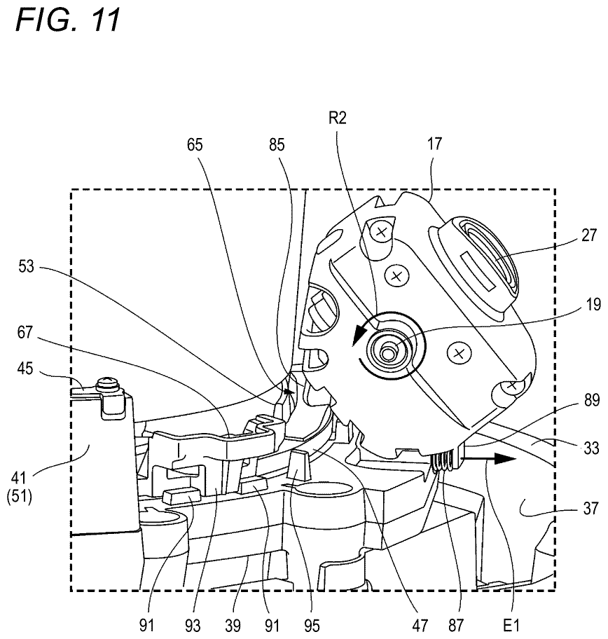

The surveillance camera 11 is a multi-camera in which each of the plurality of camera modules 17 (see FIG. 2) is mounted on a concentric circle centered on the camera unit 13. The surveillance camera 11 includes a main camera, which is the camera unit 13 equipped with a pan tilt zoom (PTZ) drive mechanism (not illustrated), and the plurality of camera modules 17, each equipped with a tilt mechanism, and each having at least an adjustable tilt angle. Each of the plurality of camera modules 17 has a tilt shaft 19 (see FIG. 11), and is configured to be tiltable and rotatable about the tilt shaft 19.

The surveillance camera 11 may have a configuration in which the camera unit 13, which is the main camera, is omitted, and may have only the plurality of camera modules 17.

FIG. 1 illustrates an example in which the surveillance camera 11 is installed on a ceiling. However, it is needless to say that the surveillance camera 11 may be installed at other locations (for example, a wall, an eave, or a pole). The surveillance camera 11 includes a decorative cover 21, a ring cover 23, and the dome cover 15, which are each sequentially disposed and hang downward from a ceiling surface.

The decorative cover 21 is fixed and attached to an installation plate 31 (see FIG. 2) described later by inserting and screwing fixing screws (not illustrated) into screw insertion holes 35 (see FIG. 1) provided at predetermined intervals along a circumferential direction of the decorative cover 21.

In the ring cover 23, each of a plurality of imaging windows 29 that allow incident light to enter a lens 27 (see FIG. 2) of each camera module 17 is disposed along a circumferential direction of the concentric circle centered on the camera unit 13.

FIG. 2 is a perspective view of the surveillance camera 11. In the surveillance camera 11 illustrated in FIG. 2, the decorative cover 21, the ring cover 23, and the dome cover 15 are not illustrated for easy understanding of the description.

In the surveillance camera 11, the installation plate 31 is directly or indirectly fixed to the ceiling which is an installation surface of the surveillance camera 11. The surveillance camera 11 includes a housing 33 attached to the fixed installation plate 31.

The installation plate 31 is formed of, for example, a sheet metal material in a substantially disk shape. The housing 33 is formed of, for example, a resin or an aluminum alloy material in a substantially cylindrical shape. A surface of the housing 33 opposite the camera unit 13 is fixed to the installation plate 31.

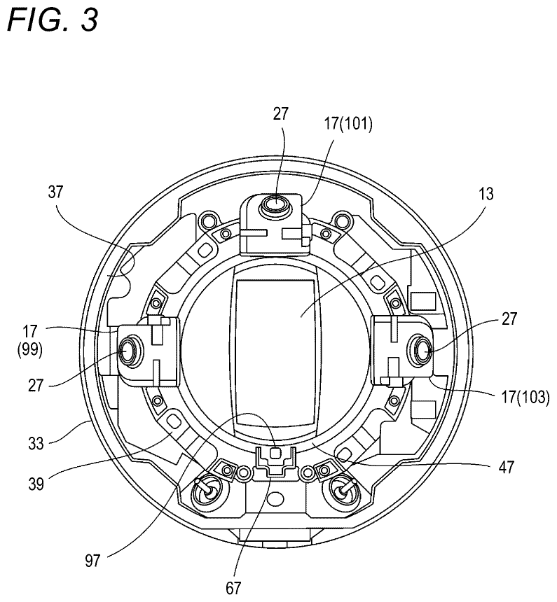

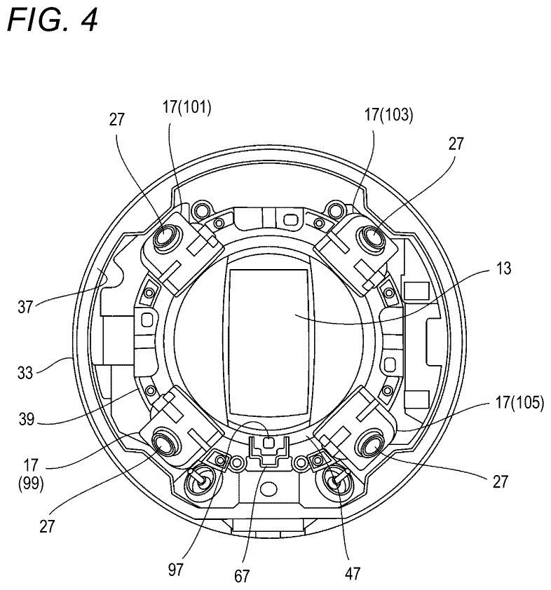

Next, a disposition example of the camera module 17 will be described with reference to each of FIGS. 3 and 4. FIG. 3 is a plan view of the housing 33. FIG. 4 is a plan view of the housing 33.

FIG. 3 illustrates an example of the surveillance camera 11 in which each of three camera modules 17 is mounted as an example, and FIG. 4 illustrates an example of the surveillance camera 11 in which each of four camera modules 17 is mounted as an example. However, the number and disposition of the camera modules 17 are not limited to the examples illustrated in FIGS. 3 and 4. The surveillance camera 11 may be capable of mounting the number of camera modules 17 (maximum of seven in Embodiment 1) corresponding to the number and positions of adjustment portions 65 described later. The number and disposition of the camera modules 17 included in the surveillance camera 11 may be optionally selected by a user.

The housing 33 is provided with an annular installation base 39 inside an outer peripheral wall 37 and on the concentric circle centered on the camera unit 13. Each of the plurality of camera modules 17 is attached to the installation base 39 to be tiltable and rotatable in the circumferential direction. Each of the plurality of camera modules 17 is attached to any position on the installation base 39, which is a position corresponding to a position of each step part 69 provided on a pedestal 47 described later.

The surveillance camera 11 illustrated in FIG. 3 illustrates a disposition example of the camera modules 17 when, for example, the surveillance camera 11 is installed in a vicinity of a wall, a pillar, or the like. The surveillance camera 11 illustrated in FIG. 4 illustrates a disposition example of the camera modules 17 when, for example, the surveillance camera 11 illustrated in FIG. 3 is not installed in the vicinity of a wall, a pillar, or the like, and an omnidirectional image around the surveillance camera 11 is captured.

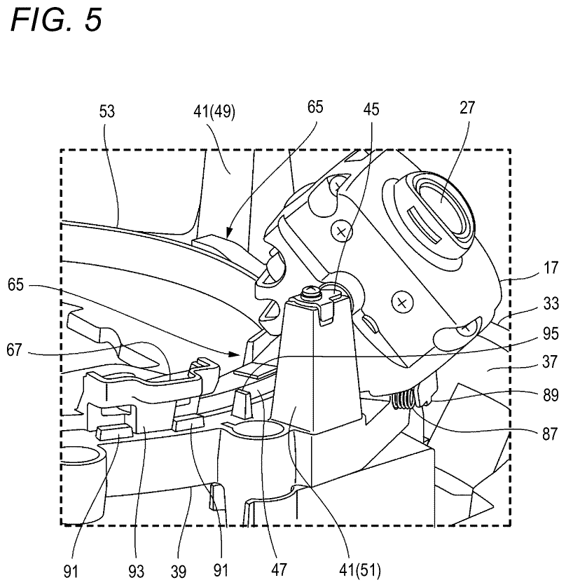

Next, an example of a tilt rotation mechanism of the camera module 17 will be described with reference to FIG. 5. FIG. 5 is an enlarged perspective view of a main portion illustrating the example of the tilt rotation mechanism. The tilt rotation mechanism includes a tilt shaft 19 and a tilt bearing 41.

The installation base 39 includes each of a plurality of tilt bearings 41 that are provided at substantially equal intervals in the circumferential direction and that protrude (stand upright) in a direction opposite to the housing 33. Two tilt bearings 41 are provided for one camera module 17, and support the camera module 17 to be tiltable and rotatable.

For example, the surveillance camera 11 illustrated in FIG. 3 includes three camera modules 17, and six tilt bearings 41 for supporting each of the three camera modules 17 to be tiltable and rotatable. Further, for example, the surveillance camera 11 illustrated in FIG. 4 includes four camera modules 17, and eight tilt bearings 41 for supporting each of the four camera modules 17 to be tiltable and rotatable.

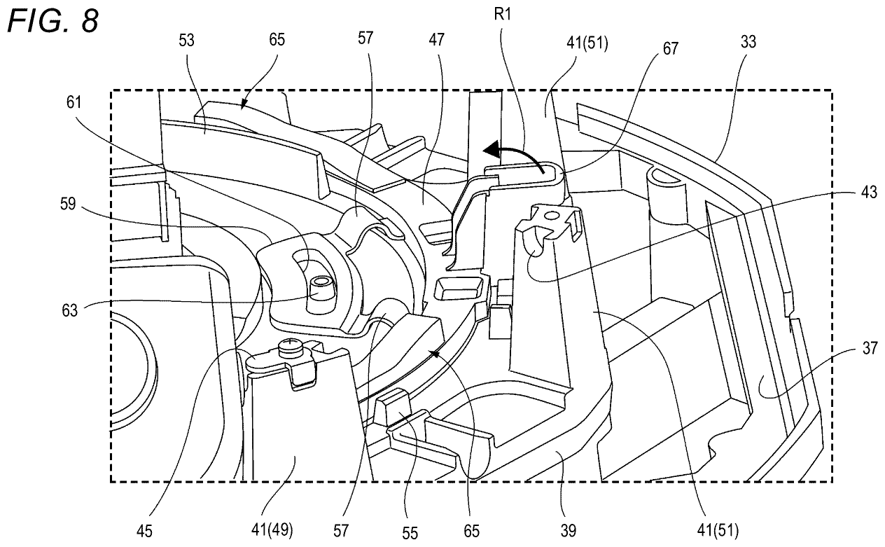

The camera module 17 has a pair of tilt shafts 19 (see FIG. 11) protruding from both side surfaces. The camera module 17 is supported to be tiltable and rotatable by inserting each of the tilt shafts 19 on both sides into a bearing recess 43 (see FIG. 8) provided at an upper end of the tilt bearing 41 standing upright on both sides with the camera module 17 interposed therebetween.

That is, the tilt bearing 41 inserted into the bearing recess 43 is restricted from being detached from the bearing recess 43 by a shaft fixing piece 45 screwed to the upper end of the tilt bearing 41.

Further, the tilt bearing 41 is formed as a single-receiving tilt bearing 51 having one bearing recess 43 for only each of the two tilt bearings 41 disposed with a lever 67 described later interposed therebetween. Further, the tilt bearing 41 is formed as double-receiving tilt bearings 49 having a pair of bearing recesses 43, except for the above single-receiving tilt bearing 51.

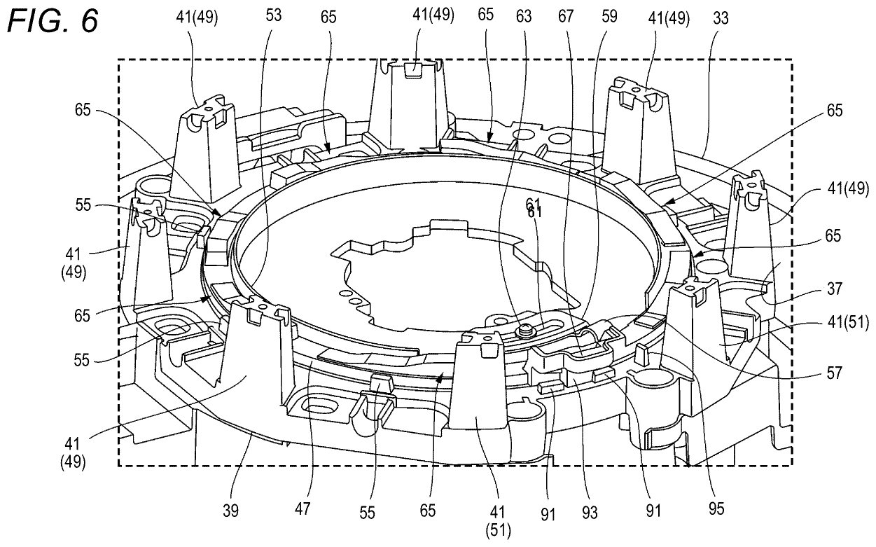

The pedestal 47 will be described with reference to FIG. 6. FIG. 6 is a perspective view illustrating an example of the pedestal 47.

The pedestal 47 is movably provided on the installation base 39. Similarly to the installation base 39, the pedestal 47 is formed in a substantially annular shape concentric with the camera unit 13. The pedestal 47 is provided to be movable (rotatable) in the circumferential direction about the camera unit 13. The pedestal 47 is rotated with an inner diameter side thereof guided by a peripheral wall 53 formed to protrude from the installation base 39 and an outer diameter side thereof guided by a guide protrusion 55 formed to protrude from the installation base 39.

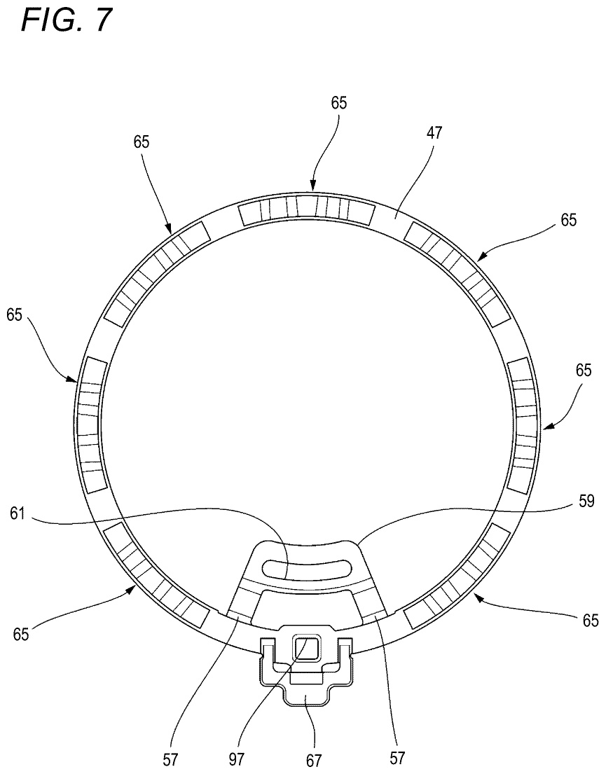

The pedestal 47 will be described with reference to each of FIGS. 7 and 8. FIG. 7 is a plan view of the pedestal 47. FIG. 8 is an enlarged view of a main portion illustrating a flexible part 57.

The pedestal 47 includes each of a plurality of the adjustment portions 65, and the lever 67. Each of the plurality of adjustment portions 65 and the lever 67 are disposed at substantially equal intervals in a circumferential direction of the pedestal 47. In the pedestal 47, a retaining portion 59 (an example of a restriction portion) is provided, via the flexible part 57, on an inner diameter side of a position where the lever 67 is provided.

Each of the plurality of adjustment portions 65 supports each of the camera module 17 and can collectively change the camera modules 17 to a predetermined tilt angle. Specifically, the adjustment portions 65 are provided at seven positions among eight equally divided positions on the pedestal 47 in the circumferential direction, and the lever 67 is provided at one position where no adjustment portion 65 is provided.

The lever 67 is provided to protrude radially outward from an outer periphery of the pedestal 47. The lever 67 is a knob for rotating the pedestal 47 along the circumferential direction, and is operated by an operator who installs the surveillance camera 11. The lever 67 is lifted in a rotation direction R1 by the operator, and is rotated to a predetermined position in the circumferential direction by passing over each of first partition plates 91 described later.

The pedestal 47 rotates (moves) in a predetermined circumferential direction in response to a rotation operation of the lever 67. Since each of the plurality of adjustment portions 65 provided on the pedestal 47 is integrally configured with the pedestal 47, the adjustment portion 65 rotates by a rotation (movement) amount of the pedestal 47 in the predetermined circumferential direction.

In the pedestal 47, the retaining portion 59 is provided on the inner diameter side of the pedestal 47. The retaining portion 59 has a pair of substantially parallel flexible parts 57 extending radially inward, and is connected to the pedestal 47 via the flexible parts 57. In the retaining portion 59, an arc-shaped curved groove 61 centered on a rotation center of the pedestal 47 is formed.

A stopper pin 63 standing upright from the installation base 39 passes through the curved groove 61. A washer is fixed to the curved groove 61 of the stopper pin 63 by a fixing screw at an upper end through which the stopper pin 63 passes. The washer is formed to have an outer diameter larger than a groove width of the curved groove 61. The retaining portion 59 regulates rising of the pedestal 47 from the installation base 39 by an operation of the lever 67, which is lifted in the rotation direction R1, with the washer fixed by the fixing screw.

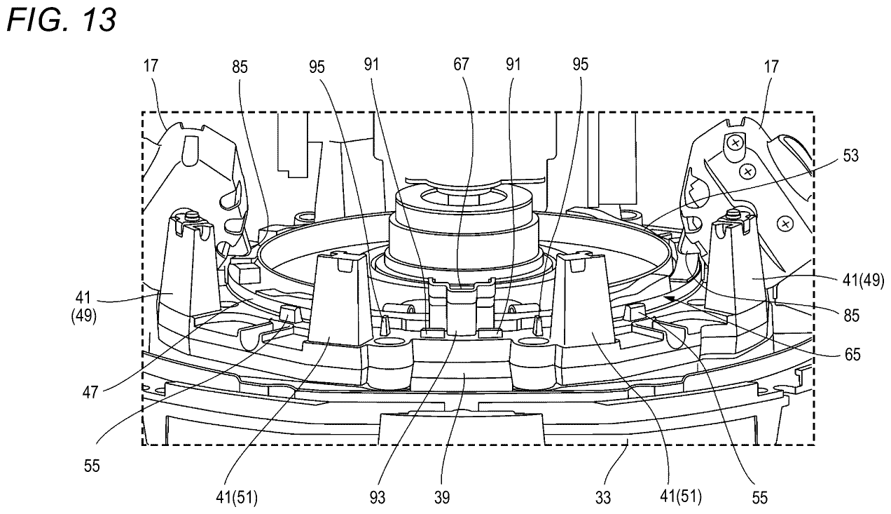

The curved groove 61 is an opening formed in a concentric circle with the pedestal 47. The curved groove 61 allows the stopper pin 63 to move in the circumferential direction in accordance with a length (rotation angle) by which a movement (rotation) of the lever 67 can be moved by each of a pair of second partition plates 95 (see FIG. 13) described later.

The flexible part 57 is bent by the operation of the lever 67 lifted in the rotation direction R1, and allows deformation of the pedestal 47 due to lifting of the lever 67.

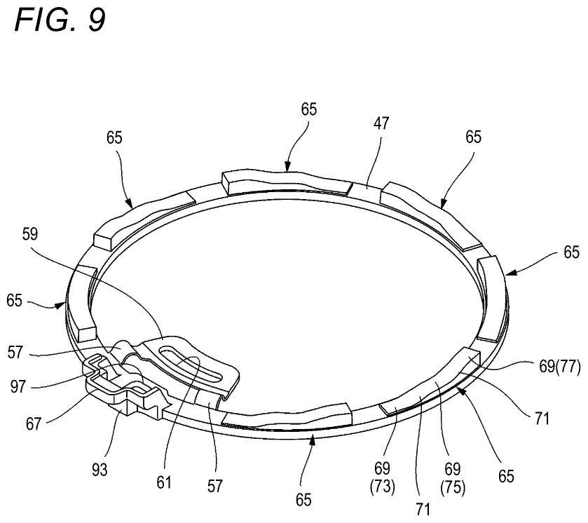

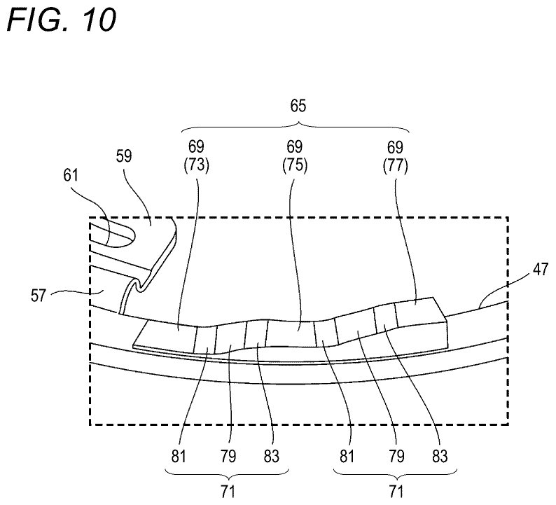

The adjustment portion 65 will be described with reference to each of FIGS. 9 and 10. FIG. 9 is a perspective view of the pedestal 47. FIG. 10 is an enlarged view of a main portion of the pedestal 47 in a vicinity of the adjustment portion 65.

Each of the adjustment portions 65 has a plurality of step parts 69 having different heights arranged in a movement direction of the pedestal 47. The step parts 69 having different heights are arranged in the same arrangement along the circumferential direction. The same arrangement is, for example, in order of height. In Embodiment 1, the adjustment portion 65 has three step parts 69 each continuously arranged to gradually decrease in height in a clockwise direction in FIG. 9.

In the adjustment portion 65, the adjacent step parts 69 are connected by a gently inclined surface 71. As an example, the inclined surface 71 between a lower step part 73 and a middle step part 75 and the inclined surface 71 between the middle step part 75 and an upper step part 77 are configured such that a lower concave surface 81 and an upper convex surface 83 are connected on both sides of an inclination sandwiching a central inclined surface 79, forming a gentle inclination that allows a support portion 85 (see FIG. 11) of the camera module 17 to smoothly slide between the plurality of step parts 69 and the inclined surface 71.

The number of step parts 69 and the height of each step part may be set to any number and height, respectively. The number of step parts 69 corresponds to the number of adjustable tilt angles of the camera module 17. The height of each step part corresponds to a degree of the adjustable tilt angle of the camera module 17.

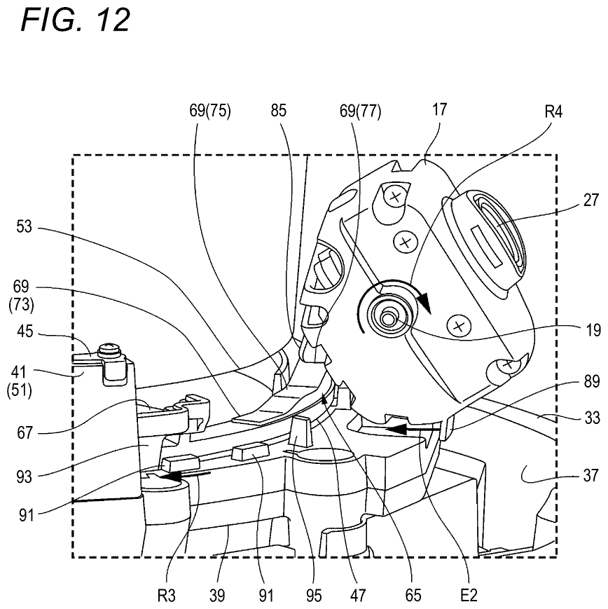

Next, adjustment of the tilt angle of the camera module 17 will be described with reference to each of FIGS. 11 and 12. FIG. 11 is a perspective view illustrating an example of adjusting the tilt angle of the camera module 17. FIG. 12 is a perspective view illustrating an example of adjusting the tilt angle of the camera module 17.

FIG. 11 illustrates an example in which the support portion 85 of the camera module 17 is located on the middle step part 75 of the adjustment portion 65. FIG. 12 illustrates an example in which the support portion 85 of the camera module 17 is located on the upper step part 77 of the adjustment portion 65.

The camera module 17 includes the support portion 85 and a spring 87. The support portion 85 is formed to protrude from a back portion of a camera case on an opposite side to the lens 27 across the tilt shaft 19. The support portion 85 is formed in a substantially triangular plate shape in a side view of the camera module 17, and one of a pair of oblique side portions sandwiching an apex angle abuts the step part 69 (the middle step part 75 in FIG. 11) to support the camera module 17 with the tilt shaft 19 as a rotation center.

The spring 87 biases the camera module 17 in a direction El (toward the camera unit 13) by an elastic force. The camera case has a spring receiving portion 89 that protrudes below the camera module 17. The spring 87 is compressed and sandwiched between the spring receiving portion 89 and the installation base 39.

Accordingly, the camera module 17 biased by the spring 87 is rotatably supported about the tilt shaft 19, and thus is biased in a rotation direction R2 about the tilt shaft 19. Therefore, the support portion 85 is biased in the rotation direction R2 by the spring 87, thereby being pressed toward the adjustment portion 65.

Each of the plurality of adjustment portions 65 is rotated in the circumferential direction corresponding to a rotation angle of the pedestal 47 based on the operation of the lever 67 by the operator. For each of the plurality of camera modules 17, the support portion 85 slides along the inclined surface 71 of the adjustment portion 65 due to a rotation of the plurality of adjustment portions 65, and supports the camera module 17 on the step part 69 having the same height. Accordingly, the surveillance camera 11 according to Embodiment 1 is configured to collectively change the tilt angle of each of the plurality of camera modules 17.

As illustrated in FIG. 12, when the operator operates the lever 67 clockwise along a circumferential direction R3, the support portion 85 of each of the plurality of camera modules 17 passes through the inclined surface 71 from the middle step part 75, slides onto the upper step part 77, and stops, based on the operation of the lever 67.

Each of the plurality of camera modules 17, whose support portion 85 is supported by the upper step part 77, is biased in a rotation direction R4 about the tilt shaft 19 by a force received by the support portion 85 from the upper step part 77. The spring 87 is compressed toward a direction E2 by the force received from the upper step part 77, and maintains a current tilt angle of each of the plurality of camera modules 17.

Accordingly, each of the plurality of camera modules 17 is adjusted to a tilt angle corresponding to a height (position) of the step part 69 on which the support portion 85 is supported, and can maintain a capture posture at the adjusted tilt angle.

For example, when the step part 69 includes three steps (the lower step part 73, the middle step part 75, and the upper step part 77), the camera module 17 can be adjusted to three different tilt angles. As for the tilt angle here, an example of collectively adjusting the tilt angles will be specifically described below with reference to a reference angle=0 (zero)° (see FIG. 1) directly below the camera unit 13.

Specifically, when the tilt angle of the camera module 17 at the middle step part 75 is 50° and an adjustment range of the tilt angle between the respective step parts 69 is 7°, the plurality of camera modules 17 are each collectively adjusted by the operation of the lever 67 to 57° at the lower step part 73, 50° at the middle step part 75, and 43° at the upper step part 77.

The adjustment range of the tilt angle of each of the plurality of camera modules 17 may be adjusted to a smaller adjustment range (for example, ±3° or ±5°) by designing the height between the respective step parts 69 to be smaller. On the other hand, the adjustment range of the tilt angle of each of the plurality of camera modules 17 may be adjusted to a larger adjustment range (for example, ±8° or ±10°) by designing the height between the respective step parts 69 to be larger.

The lever 67 will be described with reference to FIG. 13. FIG. 13 is an enlarged perspective view of a main portion of the lever 67.

The installation base 39 includes each of the at least one first partition plates 91 and a pair of second partition plates 95. Each of the pair of second partition plates 95 is provided higher than a height of each of the at least one first partition plates 91 disposed between the second partition plate 95 and the second partition plate 95.

The second partition plate 95 has a height that restricts the lever 67 from passing over. A gap in which an engagement portion 93 of the lever 67 can be disposed is formed between the first partition plate 91 and the second partition plate 95. A length along the circumferential direction between the second partition plate 95 and the second partition plate 95 is set to be equal to or less than a length of a distance between the lower step part 73 and the upper step part 77 of the adjustment portion 65. Accordingly, the support portion 85 of each of the plurality of camera modules 17 can be prevented from falling off from the adjustment portion 65.

The first partition plate 91 is provided such that the lever 67 can be disposed at a position in the circumferential direction corresponding to the height of each step part 69. The number L (L: an integer of 1 or more) of the first partition plates 91 corresponds to the number K (K: an integer of 2 or more) of the step parts 69 included in the adjustment portion 65, and (K-1) first partition plates 91 are provided. For example, when the number of the step parts 69 is three, two first partition plates 91 are provided between the second partition plate 95 and the second partition plate 95 along the circumferential direction, corresponding to the positions of the respective step parts 69 and having a gap in which the engagement portion 93 of the lever 67 can be disposed.

The lever 67 is rotated by the operation of the lever 67, the engagement portion 93 is disposed between the first partition plate 91 and the first partition plate 91 or between the first partition plate 91 and the second partition plate 95, respectively, and the rotation in the circumferential direction is restricted by the first partition plates 91 or the second partition plates 95 located on both sides in the circumferential direction with respect to the disposition position. Accordingly, the lever 67 can restrict the rotation of the pedestal 47.

Further, since the lever 67 is positioned by lifting the knob and passing over each of the first partition plates 91, a position of the lever 67 can be controlled by vibrations or impacts transmitted from outside the surveillance camera 11. Accordingly, the surveillance camera 11 can prevent the tilt angle of each of the plurality of camera modules 17 from being changed due to vibrations or impacts transmitted from the outside.

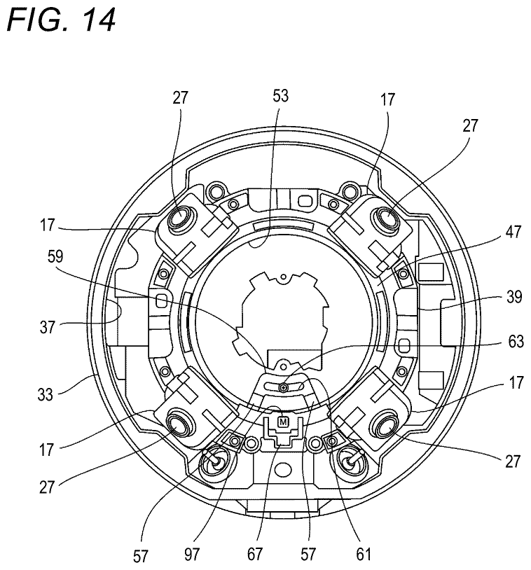

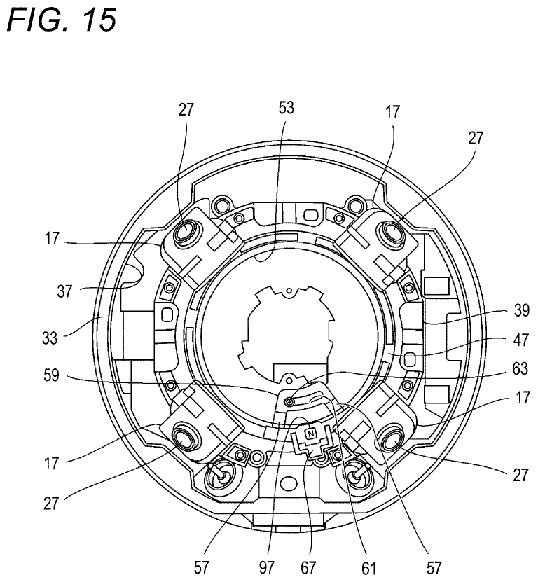

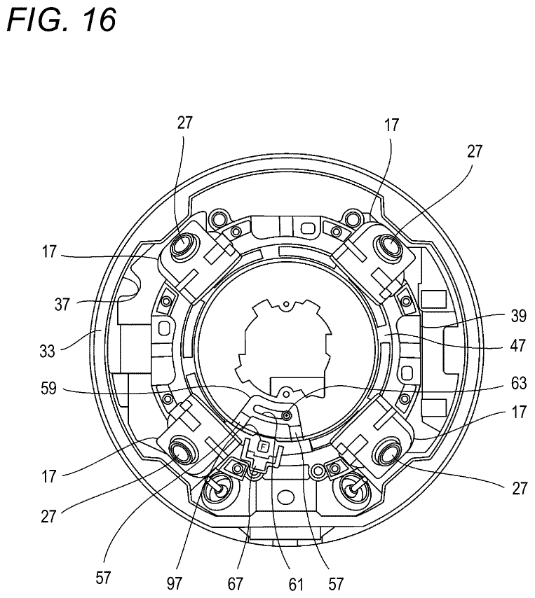

Next, a relationship between a disposition of the lever 67 and the tilt angle will be specifically described with reference to each of FIGS. 14 to 16. FIG. 14 is a plan view illustrating the lever 67 and the pedestal 47 at a position of a middle-distance mark “M”. FIG. 15 is a plan view illustrating the lever 67 and the pedestal 47 at a position of a short-distance mark “N”. FIG. 16 is a plan view illustrating the lever 67 and the pedestal 47 at a position of a long-distance mark “F”. Each mark is an example and is not limited thereto.

Each of the plurality of marks indicates the height of the step part 69 (that is, the tilt angle), that is, the current tilt angle of each of the plurality of camera modules 17. Each of the plurality of marks are disposed on the installation base 39 along the circumferential direction, with the same number of different types of marks as the number K of the step parts 69, at substantially equal intervals as the intervals of the respective step parts 69 (the lower step part 73, the middle step part 75, and the upper step part 77). In the examples illustrated in FIGS. 14 to 16, the installation base 39 is provided with the short-distance mark “N”, the middle-distance mark “M”, and the long-distance mark “F” along the clockwise direction.

As illustrated in FIG. 3, the pedestal 47 has a window hole 97 formed in a vicinity of the lever 67. The window hole 97 overlaps with any mark corresponding to a position of a rotation angle of the pedestal 47 by the lever 67. The mark overlapped with the window hole 97 is visually recognized by the operator through the window hole 97.

The short-distance mark “N” illustrated in FIG. 15 indicates that the current tilt angle of each of the plurality of camera modules 17 is an angle corresponding to the lower step part 73 of the step part 69 (for example, 57°). The middle-distance mark “M” illustrated in FIG. 14 indicates that the current tilt angle of each of the plurality of camera modules 17 is an angle corresponding to the middle step part 75 of the step part 69 (for example, 50°). Further, the long-distance mark “F” illustrated in FIG. 16 indicates that the current tilt angle of each of the plurality of camera modules 17 is an angle corresponding to the upper step part 77 of the step part 69 (for example, 43°).

Accordingly, the operator can grasp the tilt angle of each of the plurality of camera modules 17 corresponding to a current position of the lever 67 based on the type of the mark that can be visually recognized through the window hole 97.

As described above, the surveillance camera 11 according to Embodiment 1 includes a housing 33, an installation base 39 provided in the housing 33, a plurality of camera modules 17 provided on the installation base 39 to be tiltable and rotatable, and a pedestal 47 provided to be movable (rotatable) with respect to the installation base 39, in which the pedestal 47 includes a plurality of adjustment portions 65 that respectively support each of the plurality of camera modules 17 and are changeable to a plurality of different tilt angles, and a lever 67 that receives a movement (rotation) operation of the pedestal 47 and is capable of collectively adjusting the plurality of adjustment portions 65.

Accordingly, the surveillance camera 11 according to Embodiment 1 can collectively adjust the tilt angle of each of the plurality of camera modules 17 by each of the plurality of adjustment portions 65 by the movement (rotation) operation of pedestal 47 by the lever 67. Therefore, since the operator can collectively adjust the tilt angle of each of the plurality of camera modules 17 by operating the lever 67 without individually adjusting the tilt angles of the plurality of camera modules 17, the tilt angles of the plurality of camera modules 17 can be more easily adjusted. Accordingly, the surveillance camera 11 can prevent a deviation in an angle of view of a captured image captured by each of the plurality of camera modules 17.

The adjustment portion 65 in the surveillance camera 11 according to Embodiment 1 includes a plurality of step parts 69 having different heights along the movement direction (circumferential direction) of pedestal 47. Accordingly, the surveillance camera 11 according to Embodiment 1 can more easily and collectively adjust the tilt angle of each of the plurality of camera modules 17 based on the height of step part 69.

Further, in the adjustment portion 65 in the surveillance camera 11 according to Embodiment 1, two adjacent step parts are connected by the gently inclined surface 71. Accordingly, the surveillance camera 11 according to Embodiment 1 can more easily and collectively adjust the tilt angle of each of the plurality of camera modules 17 by sliding on the inclined surface 71 of the step part 69 in accordance with the movement (rotation) of pedestal 47.

The plurality of camera modules 17 in the surveillance camera 11 according to Embodiment 1 each further includes a support portion 85 that abuts the adjustment portion 65. The support portion 85 guides the camera module 17 to different step parts 69 along the inclined surface 71 of the adjustment portion 65 based on the movement (rotation) of the pedestal 47. Accordingly, in the surveillance camera 11 according to Embodiment 1, since the support portion 85 slides along the inclined surface 71 of the adjustment portion 65, the tilt angle of each of the plurality of camera modules 17 can be more easily and collectively adjusted by operating the lever 67.

Further, the camera module 17 in the surveillance camera 11 according to Embodiment 1 includes the spring 87 that rotationally biases the support portion 85 about the tilt shaft 19 of the camera module 17 in a direction toward adjustment portion 65. Accordingly, the surveillance camera 11 according to Embodiment 1 can maintain the tilt angle of each of the plurality of camera modules 17.

The pedestal 47 in the surveillance camera 11 according to Embodiment 1 is formed in a substantially annular shape, and the plurality of adjustment portions 65 are disposed on the pedestal 47 at substantially equal intervals. Accordingly, the surveillance camera 11 according to Embodiment 1 can more easily and collectively adjust the tilt angle of each of the plurality of camera modules 17 by each of the plurality of camera modules 17 moving (rotating) on the corresponding adjustment portion 65 in response to an amount of movement of the lever 67.

The plurality of adjustment portions 65 in the surveillance camera 11 according to Embodiment 1 are provided at seven positions among eight equally divided positions on the pedestal 47 in the circumferential direction. Accordingly, the surveillance camera 11 according to Embodiment 1 can collectively adjust the tilt angle of each of the plurality of camera modules 17, with a maximum of seven.

The lever 67 in the surveillance camera 11 according to Embodiment 1 can move (rotate) the pedestal 47 in the circumferential direction. The installation base 39 includes a plurality of first partition plates 91 and second partition plates 95 (an example of a partition plate). The lever 67 is restricted from moving by the plurality of first partition plates 91 in the circumferential direction. Accordingly, the surveillance camera 11 according to Embodiment 1 can move the lever 67 within adjustment ranges of the plurality of different tilt angles by restricting the movement of the lever 67 with the first partition plates 91. Therefore, the surveillance camera 11 can more easily and collectively adjust the tilt angle of each of the plurality of camera modules 17.

Further, the plurality of first partition plates 91 and second partition plates 95 in the surveillance camera 11 according to Embodiment 1 include the plurality of first partition plates 91 having a first height and the pair of second partition plates 95 having a second height higher than the first height, and each of the plurality of first partition plates 91 is disposed between the pair of second partition plates 95. When pulled up, the lever 67 passes over the first partition plate 91 and is disposed between two adjacent first partition plates 91 or between the first partition plate 91 and the second partition plate 95. Accordingly, the surveillance camera 11 according to Embodiment 1 can easily align the lever 67 to a position corresponding to any tilt angle by restricting the movement (rotation) of the lever 67 with the first partition plates 91. Further, even when impacts (external forces) or vibrations are applied from outside the surveillance camera 11, the surveillance camera 11 can prevent the deviation in the tilt angle of each of the plurality of camera modules 17.

The pedestal 47 in the surveillance camera 11 according to Embodiment 1 further includes the retaining portion 59 (an example of the restriction portion) on a side opposite to the lever 67. The retaining portion 59 restricts the movement (rotation) of the lever 67 outside the movement (rotation) range in the circumferential direction allowed by all the partition plates (first partition plates 91 and second partition plates 95). Accordingly, the surveillance camera 11 according to Embodiment 1 can restrict the operation of the lever 67 beyond the movement range corresponding to a range of the tilt angle adjustable by the adjustment portion 65 even when the lever 67 is pulled up to a height at which the lever 67 passes over the second partition plate 95.

The retaining portion 59 in the surveillance camera 11 according to Embodiment 1 has flexibility in the retaining portion 59, and connects the flexible part 57 that is bent by a pulling-up operation of the lever 67. Accordingly, the surveillance camera 11 according to Embodiment 1 can use the flexible part 57 to absorb bending of the pedestal 47 during the pulling-up operation of the lever 67.

The pedestal 47 in the surveillance camera 11 according to Embodiment 1 further includes the plurality of marks corresponding to the plurality of different tilt angles that can be adjusted by the adjustment portion 65, and the window hole 97 that allows the mark indicating the current tilt angle of each of the plurality of camera modules 17 to be visually recognized corresponding to the disposition of the lever 67. Accordingly, the surveillance camera 11 according to Embodiment 1 enables the operator to visually recognize the tilt angle of each of the plurality of camera modules 17 corresponding to the current position of lever 67.

The number of the plurality of camera modules 17 in the surveillance camera 11 according to Embodiment 1 is three. Accordingly, the surveillance camera 11 according to Embodiment 1 can simultaneously capture images in three different directions by each of the camera modules 17.

The number of the plurality of camera modules 17 in the surveillance camera 11 according to Embodiment 1 is four. Accordingly, the surveillance camera 11 according to Embodiment 1 can simultaneously capture images in four different directions by each of the camera modules 17.

Therefore, according to the surveillance camera 11 according to Embodiment 1, the tilt angles of all the camera modules 17 can be collectively adjusted.

Although various embodiments have been described above with reference to the accompanying drawings, the present disclosure is not limited to such examples. It is apparent a person skilled in the art that various changes, corrections, substitutions, additions, deletions, and equivalents can be conceived within the scope of the claims, and it is understood that such modifications also belong to the technical scope of the present disclosure. The components in the various embodiments described above may be optionally combined without departing from the gist of the invention.

The present application is based on Japanese Patent Application (Japanese Patent Application No. 2022-181381) filed on Nov. 11, 2022, and the contents thereof are incorporated herein by reference.

### INDUSTRIAL APPLICABILITY

The present disclosure is useful as a camera capable of collectively adjusting tilt angles of all camera modules.

### REFERENCE SIGNS LIST

11: surveillance camera
17: camera module
33: housing
39: installation base
47: pedestal
57: flexible part
59: retaining portion
65: adjustment portion
67: lever
69: step part
71: inclined surface
85: support portion
87: spring
91: first partition plate
95: second partition plate
97: window hole

1. A camera comprising:
a housing;
an installation base provided in the housing;
a plurality of camera modules provided on the installation base to be tiltable and rotatable; and
a pedestal provided to be movable with respect to the installation base, wherein
the pedestal includes
a plurality of adjustment portions that respectively support each of the plurality of camera modules and are changeable to a plurality of different tilt angles, and
a lever that receives a movement operation of the pedestal and is capable of collectively adjusting the plurality of adjustment portions.

2. The camera according to claim 1, wherein
the adjustment portion includes a plurality of step parts having different heights along a movement direction of the pedestal.

3. The camera according to claim 2, wherein
in the adjustment portion, two adjacent step parts are connected by a gently inclined surface.

4. The camera according to claim 3, wherein
each of the plurality of camera modules further includes a support portion that abuts the adjustment portion, and
the support portion guides the camera module to different step parts along the inclined surface of the adjustment portion based on a movement of the pedestal.

5. The camera according to claim 4, wherein
the camera module includes a spring that rotationally biases the support portion about a tilt shaft of the camera module in a direction toward the adjustment portion.

6. The camera according to claim 1, wherein
the pedestal is formed in a substantially annular shape, and
the plurality of adjustment portions are disposed on the pedestal at substantially equal intervals.

7. The camera according to claim 1, wherein
the plurality of adjustment portions are provided at seven positions among eight equally divided positions on the pedestal in a circumferential direction.

8. The camera according to claim 7, wherein
the lever is movable on the pedestal in the circumferential direction,
the installation base includes a plurality of partition plates, and
the lever is restricted from moving by the partition plates in the circumferential direction.

9. The camera according to claim 8, wherein
the plurality of partition plates include a plurality of first partition plates having a first height and a pair of second partition plates having a second height higher than the first height, each of the plurality of first partition plates is disposed between the pair of second partition plates, and
the lever is disposed between two adjacent partition portions by passing over the first partition plate when pulled up.

10. The camera according to claim 9, wherein
the pedestal further includes a restriction portion on a side opposite to the lever, and
the restriction portion restricts movement of the lever outside a movement range in the circumferential direction allowed by all the partition plates.

11. The camera according to claim 10, wherein
the restriction portion includes a flexible part that has flexibility and bends during a pulling-up operation of the lever.

12. The camera according to claim 1, wherein
the pedestal further includes
a plurality of marks that respectively correspond to each of the plurality of different tilt angles adjustable by the adjustment portion, and
a window hole that allows a mark indicating a current tilt angle of each of the plurality of camera modules to be visually recognized corresponding to a disposition of the lever.

13. The camera according to claim 1, wherein the number of the plurality of camera modules is three.

14. The camera according to claim 1, wherein the number of the plurality of camera modules is four.
